(19) United States
(12) Patent Application Publication
(10) Pub. No.: US 2014/0100930 A1
(43) Pub. Date: Apr. 10, 2014

(54) REDEMPTION RECORDATION AND VERIFICATION

(71) Applicant: AMAZON TECHNOLOGIES, INC., Reno, NV (US)

(72) Inventors: Gustavo Eduardo Lopez, Seattle, WA (US); Michael M. George, Mercer Island, WA (US)

(73) Assignee: AMAZON TECHNOLOGIES, INC., Reno, NV (US)

(21) Appl. No.: 13/647,104

(22) Filed: Oct. 8, 2012

(51) Int. Cl. G06Q 30/02

(52) U.S. Cl. CPC G06Q 30/0222
USPC 705/14.23

(57) ABSTRACT

The collection of voucher redemption information may reduce instances of redemption error or redemption fraud, which benefits both consumers and merchants. The collection of voucher redemption information may involve a service receiving a selection of a voucher for redemption from an application on an electronic device, in which the voucher was previously acquired by a consumer through a deal offered by a merchant. The service may subsequently direct the application to acquire a credential to complete the redemption of the voucher. In various instances, the credential may be a merchant confirmation credential of the merchant or a consumer redemption credential of the consumer. The service may receive the credential from the application on the electronic device, and store a record of the voucher redemption for the voucher in a voucher redemption database, in which the record includes the credential.

### BACKGROUND

Merchants may send out deals to promote products and services. In one example, a merchant may use a service provider to send out emails that offer discounts on products or services. Such emails may entice consumers to purchase vouchers that entitle consumers to obtain the products or services at discounts or provide other perks. Through the offering of these deals, merchants may build lasting relationships with new consumers and promote recurring business with existing consumers.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative architecture for implementing the recordation and verification of deal redemptions.

FIG. 2 shows illustrative user interface pages that enable a consumer to prompt a merchant to input a merchant confirmation credential for completing redemption of a voucher.

FIG. 3 shows illustrative user interface pages displayed on an electronic device that enable a merchant to prompt a consumer to input a consumer redemption credential to complete a voucher redemption.

FIG. 4 is a schematic diagram of illustrative components implemented by the servers of the service provider to distribute deals and record the redemption of deals, along with illustrative components in multiple electronic devices that interface with the servers.

FIG. 5 is a flow diagram of an illustrative process for using an electronic device to prompt a merchant to provide a merchant confirmation credential to complete redemption of a voucher by the consumer.

FIG. 6 is a flow diagram of an illustrative process for using an electronic device to prompt a consumer to provide a consumer redemption credential to complete redemption of a voucher by the consumer.

FIG. 7 is a flow diagram of an illustrative process for using records of consumer voucher redemption to provide a voucher payment to a merchant or refund the voucher payment to a consumer.

FIG. 8 is a flow diagram of an illustrative process for using a record of consumer voucher redemption to provide voucher redemption status.

### DETAILED DESCRIPTION

### Overview

The disclosure is directed to architectures and techniques for using applications on electronic devices to record the redemption of vouchers by consumers at places of businesses operated by merchants. Consumers may acquire vouchers through deals offered by merchants. The deals may be distributed by a service provider that acts on the behalf of the merchants. For example, the service provider may be a deal aggregator and distributor that collects deals from multiple merchants, and presents the deals as electronic communications (e.g., emails) that are distributed to subscribers of the service provider. The service provider may distribute the deals on a predetermined interval, such as on a daily or weekly basis. The vouchers that are distributed through the deals may provide discounts or other perks on items that are offered by the merchants. The items may include tangible items, intangible items, products, goods, services, a bundle of items, digital goods, digital services, events, and the like. In some instances, the consumers may purchase the vouchers from the service provider in exchange for monetary payments.

However, in other instances, the service provider may distribute the vouchers free of charge to subscribers as the merchants intended the vouchers to be gratuitous. In such instances, a voucher may have no monetary value by itself, but provides a discount on one or more items to a consumer. Alternatively, the voucher may be a promise to the consumer that the consumer is entitled to purchase one or more of a limited number of items, or otherwise entitles the consumer to an exclusive offer of privilege or benefit associated with one or more items (e.g., free upgrade, complimentary gift, free shipping, etc.) that is otherwise not available to the general public.

The service provider that provides the vouchers to the consumers on behalf of the merchants may further use the records of voucher redemptions by the consumers to perform additional tasks. For example, upon redemption of a purchased voucher by a consumer, the service provider may transfer an amount of money that the consumer paid for a particular voucher to the merchant that offered the voucher. In other instances, the service provider may use the records of voucher redemptions to develop or supplement consumer profiles of the consumers that redeemed the vouchers. In this way, the service provider may gain knowledge and insight into the interests and the purchasing habits of consumers from the voucher redemptions.

In some embodiments, a consumer desiring to redeem a voucher at a merchant may use a consumer application on an electronic device to present the voucher to the merchant. The consumer may further use the consumer application to prompt the merchant to input a merchant confirmation credential that completes the voucher redemption. The consumer application may receive the input of the merchant confirmation credential, and transmit such voucher redemption information to the service provider for recordation.

In other embodiments, a merchant may use a merchant application on an electronic device to retrieve a voucher from a database upon a request of the consumer that wishes to redeem the voucher. The merchant application may further prompt the consumer to input a consumer redemption credential to complete the voucher redemption. The merchant application may receive the input of the consumer redemption credential, and transmit such voucher redemption information to the service provider for recordation.

The systematic collection of voucher redemption information may reduce instances of redemption error or redemption fraud. For example, when a consumer disputes that the consumer had actually used a voucher, the service provider may use the consumer redemption credential that is inputted by the consumer at the time of the redemption as proof that the consumer has in fact used the voucher. In other instances, the use of accurate voucher redemption records may also enable a service provider to adopt pay-on-redemption for the merchants, rather than transferring the money collected from the consumers for purchased vouchers upfront to the merchants. Paying the merchants upfront for vouchers that are sold by the service provider on their behalf may allow the merchants to be paid for vouchers that they have not yet honored. As a result, such upfront payment may lessen the incentives for the merchants to keep accurate track of voucher redemptions. In turn, deficiencies in redemption recordkeeping may result in the service provider having to refund a consumer the cost of a voucher in the event of a consumer dispute, even if the consumer has in fact redeemed the voucher.

On the other hand, pay-on-redemption means that a merchant is not paid by the service provider for a purchased voucher until the voucher is actually redeemed, thereby lessening the financial risk incurred by the service provider. In some instances, the service provider may incentivize a merchant to participate in pay-on-redemption by charging a decreased service fee that reflects the lessened risk to the service provider. Further, the use of merchant applications and consumer applications to record voucher redemptions may produce highly accurate yet conveniently obtained voucher redemption records. Thus, merchants do not have to adopt expensive and time consuming recordkeeping systems and procedures. As a result, merchants are likely to be more open to the idea of pay-on-redemption as a fair and equitable payment scheme.

The systematic collection and use of voucher redemption information by the service provider may also provide benefits to consumers. For example, since redeemed vouchers are likely to be captured by either a merchant application or a consumer application, a service provider may institute a procedure in which a consumer may be automatically refunded the amount paid for a voucher if the consumer failed to use the voucher by a predetermined date. In this way, a consumer that fails to redeem a voucher may be assured of a refund even if the consumer forgets or is otherwise unable to use the voucher.

### Illustrative System Architecture

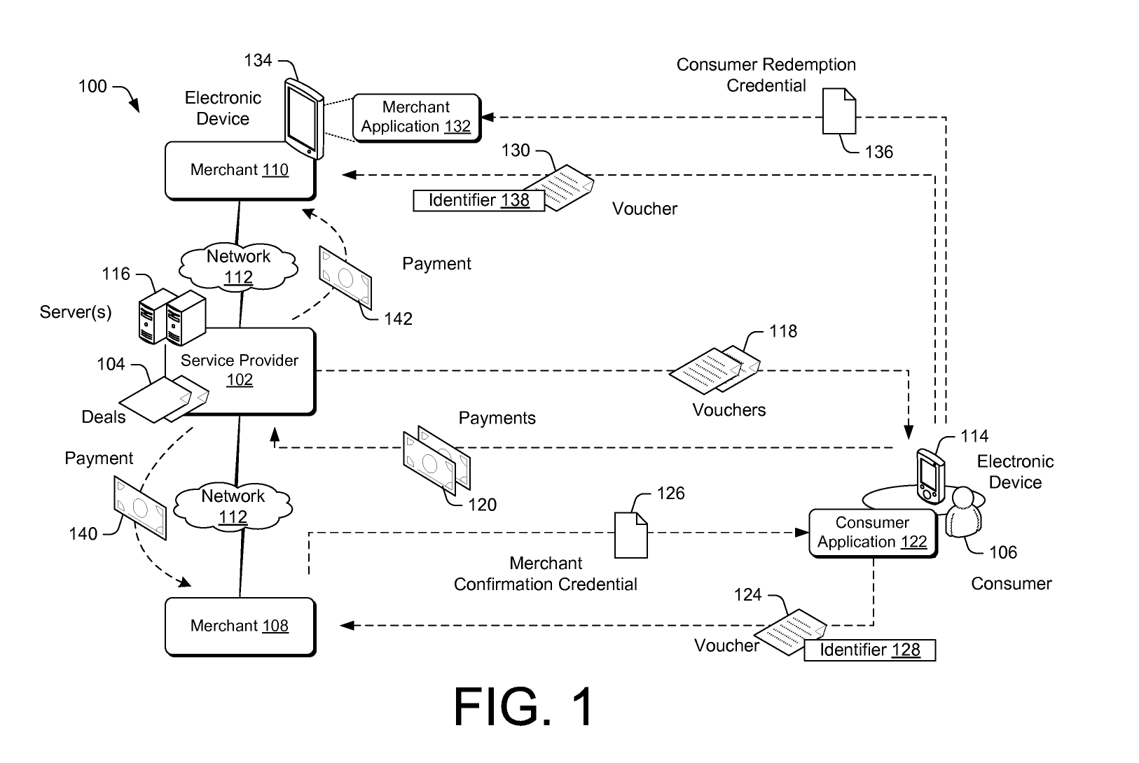

FIG. 1 is a schematic diagram of an illustrative architecture 100 for implementing the recordation and verification of deal redemptions. The service provider 102 may be a deal aggregator that works with one or more merchants to provide deals 104 to consumers, such as the consumer 106. The merchants may include a first merchant 108 and a second merchant 110. The service provider 102 may collect the deals 104 from the merchants and distribute the deals 104 to consumers that have signed up to receive the deals 104 from the service provider 102. The service provider 102 may distribute the deals 104 on a periodic basis, such as on a daily basis, a weekly basis, etc. In some instances, the consumers may sign up for the deals 104 from the service provider 102 because of the reputation of the service provider 102 as being a trustworthy and reliable distributor of quality deals.

Each of the merchants 108 and 110 may be a brick-and-mortar merchant and/or an online merchant that offers products or services for sale to consumers. In some instances, the service provider 102 may also be a merchant that is concurrently engaged in the business of selling products or services. In various embodiments, the service provider 102 may use electronic communications to convey deals to the consumer 106 via a network 112. The network 112 may be a local area network (“LAN”), a larger network such as a wide area network (“WAN”), or a collection of networks, such as the Internet. The electronic communications may be in the form of emails, web pages, as well as other forms of electronic media. Further, the service provider 102 may also use the network 112 to collect the deals 104 from the merchants, such as the merchants 108 and 110.

In some embodiments, the deals may be selected for a consumer 106 by a deal distribution program that resides on one or more servers 116 of the service provider 102. The deal distribution program may select each deal for the consumer 106 based on a relevancy of the deal to the consumer 106. For example, the deal distribution program may select deals for distribution to the consumer 106 based on factors such as past purchase behaviors of the consumer 106, a geographical location of the consumer 106, a gender of the consumer 106, environment factors related to the consumer 106, and/or other factors.

The consumer 106 may use an electronic device 114 to view the deals that are received via the network 112. The electronic device 114 may be a mobile communication device, a smart phone, a portable computer, a tablet computer, a desktop computer, a slate computer, or any other electronic device that is equipped with network communication components to receive and transmit data, data processing components to process data, and user interface components to receive data from and present data to a user. The electronic device 114 may include an email client and/or a web browser that enables the consumer 106 to access the electronic communications that present deals.

The deals 104 may convey items that are provided by a merchant (e.g., a merchant 108) and/or provide discounted prices or other perks on the items. Each deal offered by the service provider 102 on behalf of a merchant may include terms and conditions. The terms and conditions of a deal may specify the discount associated with the deal, a threshold minimum or maximum number of participants in the deal, a launch date for the deal, and/or so forth. Each of the deals may further include deal information. The deal information may include an expiration date of the deal, information about the one or more items being offered in associated with the deal, such as a text description of each item, video content associated with each item, audio content associated with each item, or a combination thereof.

In some embodiments, the deal may have monetary value. For example, the deal may be in the form of a voucher that is redeemable for one or more products or one or more services, the voucher being purchased by a consumer at a discounted price. In other embodiments, a voucher may have no monetary value by itself, but provides a discount on one or more items to a consumer. Alternatively, the voucher may be a promise to the consumer that the consumer is entitled to purchase one or more of a limited number of items, or otherwise entitles the consumer to an exclusive offer of privilege or benefit associated with one or more items (e.g., a rebate, a credit, a free upgrade, a complimentary gift, free shipping, etc.) that is otherwise not available to the general public. For example, the voucher may be a twenty percent off coupon that can be used to purchase one or more items at a discount.

The consumer 106 may purchase vouchers 118 through the electronic communications that convey deals to the consumer 106. For example, the consumer 106 may receive an email on the electronic device 114 that shows a deal on a product. The email may contain a hyperlink to an associated product web page. The associated product web page may include a link that enables the consumer 106 to acquire the deal. Once the consumer 106 has acquired the deal, the consumer 106 may receive a voucher that enables the consumer to redeem the deal at a later date. In another example, the consumer 106 may use a web browser to navigate to a web page of the service provider 102 that shows deals. The consumer 106 may then use a corresponding link on the web page to acquire a voucher through the deal. In various embodiments, an acquired voucher may include information such as a voucher identifier, a description of each product or service that is the subject of the voucher, terms and conditions for redemption, and/or other pertinent information. A voucher identifier may be in the form of numbers, letters, symbols, or combinations thereof. The consumer 106 may store the acquired voucher electronically in a data store on the servers 116 of the service provider 102, or in a memory of the electronic device 114. Alternatively or concurrently, the consumer 106 may also print out a copy of the acquired voucher.

In instances in which deals have monetary values, the consumer 106 may purchase vouchers during deal acquisitions. In such instances, the consumer 106 may provide payments 120 to the service provider 102. For example, the consumer 106 may give permission for the service provider 102 to charge a payment instrument of the consumer 106, transfer funds to the service provider 102, apply an existing credit with the service provider 102 to the purchase, and/or so forth. However, a payment may alternatively or concurrently include non-monetary elements. For example, a payment may include a bartering of goods to the service provider 102, performing services for the service provider 102, renewing an existing agreement with the service provider 102, promising to refrain from performing certain actions, and/or so forth.

The consumer 106 may redeem a voucher at a physical location of a merchant. In one scenario shown in FIG. 1, the consumer 106 may visit a brick-and-mortar store of the merchant 108. The consumer 106 may use a consumer application 122 on the electronic device 114 to show the merchant 108 an electronic version of a voucher 124. The voucher 124 may be issued by the merchant 108. The consumer application 122 may further prompt the merchant 108 to enter a corresponding merchant confirmation credential 126 if the merchant 108 agrees that the voucher 124 may be redeemed. Thus, assuming that the merchant 108 inputs the correct merchant confirmation credential 126 into the consumer application 122 (and in some instances one or more other redemption criteria are met), the service provider 102 may store a record indicating that the voucher 124 is redeemed. The redemption record for the voucher 124 may include voucher redemption information, such as the merchant confirmation credential 126 and a unique voucher identifier 128 of the voucher 124.

In another scenario shown in FIG. 1, the consumer 106 may visit a brick-and-mortar store of the merchant 110. The consumer 106 may indicate to the merchant 110 that the consumer 106 desires to redeemed a voucher 130 issued by the merchant 110. The merchant 110 may input a consumer identifier or a voucher identifier provided by the consumer 106 into a merchant application 132 that is running on an electronic device 134. The electronic device 134 may be a mobile communication device, a smart phone, a portable computer, a tablet computer, a desktop computer, a slate computer, or any other electronic device that is equipped with network communication components to receive and transmit data, data processing components to process data, and user interface components to receive data from and present data to a user.

Based on the consumer identifier or the voucher identifier, the merchant application 132 may retrieve the voucher 130 from a memory of the electronic device 134 or a data store of the servers 116. The merchant application 132 may further prompt the consumer 106 to enter a consumer redemption credential 136 to confirm that the consumer 106 desires to redeem the voucher 130. Thus, assuming that the consumer 106 inputs the consumer redemption credential 136 into the merchant application 132 (and in some instances one or more other redemption criteria are met), the service provider 102 may store a record indicating that the voucher 130 is redeemed. The redemption record for the voucher 130 may include voucher redemption information, such as the consumer redemption credential 136 and a unique voucher identifier 138 of the voucher 130.

The service provider 102 may use the records of voucher redemptions by the consumer 106 to perform additional tasks. For example, if the consumer 106 purchased the voucher 124 and the merchant 108 previously agreed to be paid upon redemption, the service provider 102 may transfer the payment 140 to the merchant 108 following the redemption. In some instances, the payment 140 may include a payment amount that is less than the full purchase amount of the voucher 124, as the service provider 102 may retain a portion of the purchase amount as a service fee. In a contrasting example, the merchant 110 may have an upfront payment agreement with the service provider 102. In such a case, the merchant 110 may have already received a payment 142 from the service provider 102 prior to the redemption of the voucher 130 by the consumer 106.

In other embodiments, the service provider 102 may use the records of the voucher redemptions by the consumer 106 to further develop or supplement the consumer profile of the consumer 106. For example, a voucher redemption record may include location information (e.g., street address) of a particular store of the merchant 110 at which the voucher 130 was redeemed. Accordingly, a deal distribution program on the servers 116 of the service provider 102 may use such location information as one of the factors in determining whether to distribute particular future deals to the consumer 106. In other words, the service provider 102 may leverage the information in the voucher redemption records to gain knowledge and insight into the interests and purchasing habits of consumers for the purpose of distributing deals.

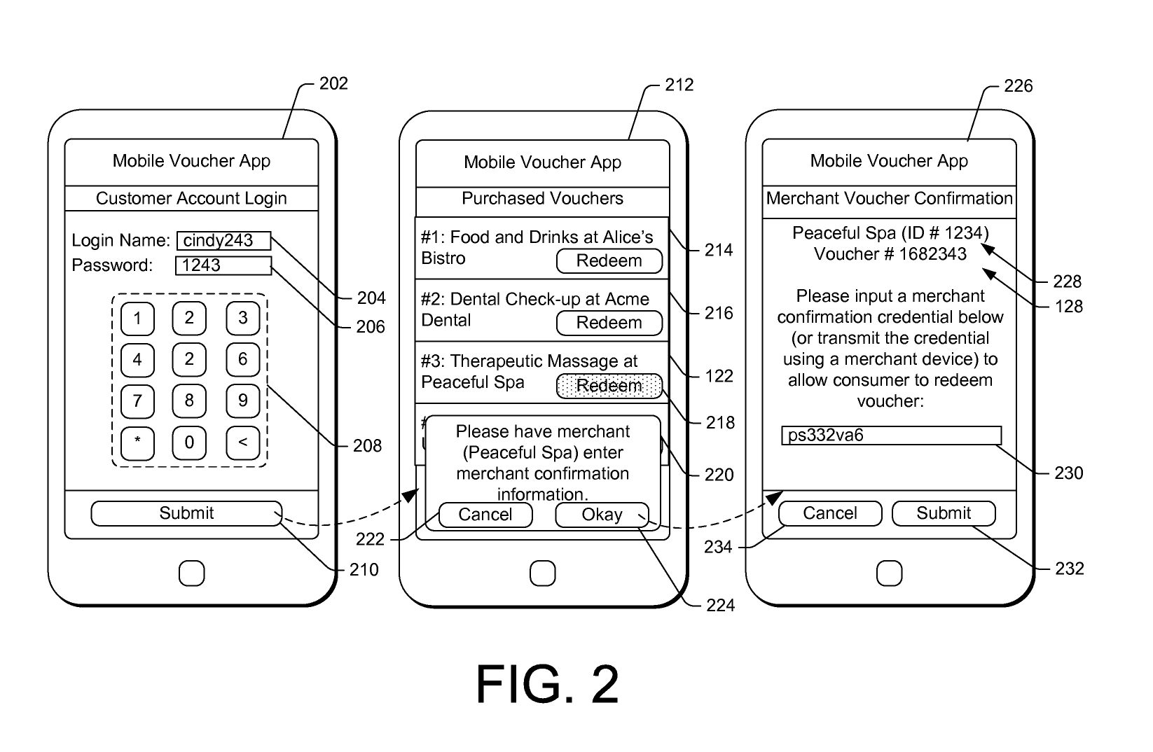

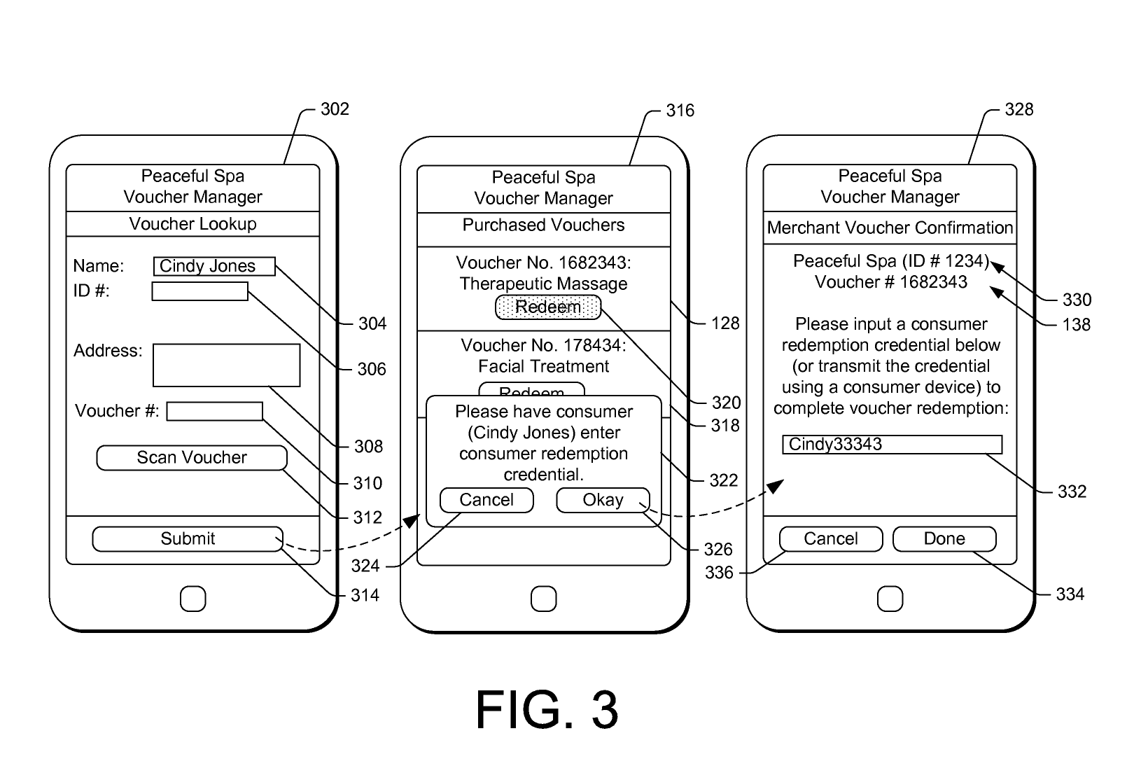

While the recordation and analysis of voucher redemption information is illustrated in FIG. 1 as pertaining to vouchers purchased by the consumer 106, it will be appreciated that the techniques and procedures described are equally applicable to vouchers that are acquired by one or more consumers through other means. Additionally, the operations of the consumer application 122 are further illustrated below in FIG. 2. Likewise, the operations of the merchant application 132 are further illustrated below in FIG. 3.

### Example User Interfaces

FIG. 2 shows illustrative user interface pages displayed on the electronic device 114. The user interface pages may enable the consumer 106 to prompt a merchant to input a merchant confirmation credential for completing the redemption of a voucher. The consumer application 122 may initially display a user interface page 202 to enable a consumer 106 to access a corresponding customer account. Once the consumer 106 has logged into the customer account, the consumer 106 may have the ability to view and redeem vouchers that have been purchased from merchants.

The user interface page 202 may include input fields, such as a login name field 204 and a password field 206, which enables the consumer 106 to enter authentication credentials for access the customer account. In some embodiments, the password field 206 may be a personal identification number (PIN) field. In such embodiments, the user interface page 202 may provide a virtual keypad 208 that enables the consumer 106 to enter a password. The use of the virtual keypad 208 to enter a password may greatly speed up the login process, thereby making the overall redemption experience more convenient for the consumer 106. However, in other instances, a full alphanumeric keyboard may be used in place of the virtual keypad 208. Following entry of the authentication credentials, the consumer 106 may activate the submit option 210 to cause the consumer application 122 to authenticate the consumer 106. The consumer application 122 may perform authentication by contacting an authentication module on the servers 116 or using authentication information that is stored in the electronic device 114. It will be appreciated that while the user interface page 202 is illustrated as having the login name field 204 and the password field 206, one or more other authentication credential input fields may be alternatively or concurrently used in other embodiments.

Once the consumer 106 has been authenticated by the consumer application 122, the consumer application 122 may display the user interface page 212. The user interface page 212 may display a list of vouchers that are available for redemption by the consumer 106. For example, the user interface page 212 may display the vouchers 124, 214, and 216. In some embodiments, the list of vouchers that are displayed may only include vouchers that may be redeemed at merchant locations that are within a predetermined distance of the current geographical position of the consumer 106. The consumer application 122 may determine the current geographical position using a positioning component (e.g., GPS sensor) of the electronic device 114.

The consumer 106 may redeem a voucher by selecting a corresponding redeem option of the voucher. For example, the consumer 106 may redeem the voucher 124 by selecting the redeem option 218. In response to the activation of the redeem option 218, the consumer application 122 may display an alert message 220. The alert message 220 may indicate that a corresponding merchant, such as merchant 108, is to enter a merchant confirmation credential to complete the redemption of the voucher. In some instances, the alert message 220 may prompt the consumer to hand the electronic device 114 to the merchant 108. The alert message 220 may include a cancel option 222 and an acknowledgement option 224.

The selection of the acknowledgement option 224 may cause the consumer application 122 to display the user interface page 226. However, in some embodiments, the display of the alert message 220 may be eliminated. In such embodiments, the consumer application 122 may directly display the user interface page 226 once the redeem option 218 is selected. The user interface page 226 may display voucher identification information. For instance, the voucher identification information may include a merchant identifier 228, as well as the unique voucher identifier 128 of the voucher 124. The user interface page 226 may also display instructions that prompt the merchant to enter the merchant confirmation credential 126.

In some embodiments, the merchant 108 may enter the merchant confirmation credential 126 in the form of a code into a text entry field 230 of the user interface page 226. For example, the merchant confirmation credential may be alphanumeric text. The merchant may use a submit option 232 to submit the merchant confirmation credential 126 to the consumer application 122. Alternatively, the merchant 108 may use the cancel option 234 to abort the entry of the merchant confirmation credential 126.

In other embodiments, the merchant 108 may use short range communication to transfer the merchant confirmation credential 126 from an electronic device of the merchant 108 to the consumer application 122. In such embodiments, the electronic device 114 and the electronic device of the merchant 108 may be equipped with near field communication (NFC) transceivers, Bluetooth transceivers, Wi-Fi transceivers, or infrared transceivers that enable the devices to exchange data. The merchant confirmation credential 126 may be stored as encrypted or unencrypted electronic data. Accordingly, the merchant 108 may use an application on its electronic device to initiate a broadcast of the merchant confirmation credential 126 through a short range transceiver. Meanwhile, the consumer application 122 may use a short range transceiver of the electronic device 114 to receive the merchant confirmation credential 126. In some instances, the consumer application 122 may perform decryption of the received electronic data to obtain the merchant confirmation credential 126.

In additional embodiments, the consumer application 122 may use an image acquisition component or an acoustic receive component of the electronic device 114 to obtain the merchant confirmation credential 126 from the merchant 108. In some instances, the merchant 108 may embed the merchant confirmation credential 126 in an image. The image may be a barcode, a matrix code, a quick response (QR) code, an Aztec code, a MaxiCode, or so forth. Accordingly, the merchant 108 may provide the image, and the image acquisition component (e.g., camera) of the electronic device 114 may acquire and transfer the image to the consumer application 122. Subsequently, the consumer application 122 may extract the merchant confirmation credential 126 from the image.

In other instances, the merchant 108 may use an application on an electronic device to cause a speaker of the electronic device to play an artificially synthesized sound. The merchant confirmation credential 126 may be embedded as encrypted or unencrypted acoustic data in the artificially synthesized sound. The sound may be received by the acoustic receiver component (e.g., a microphone) of the electronic device 114. The consumer application 122 may extract the merchant confirmation credential 126 from the sound, in which the extraction may include decrypting the acoustic data in the sound. However, in additional instances, rather than the artificially synthesized sound, the electronic device 114 may simply receive a human speech input of the merchant confirmation credential 126 through its acoustic receiver component, which may be processed by a speech-to-text algorithm and passed to the consumer application 122.

The consumer application 122 may send the obtained merchant confirmation credential 126 as a part of a redemption request for the voucher 124 to the servers 116 of the service provider 102. In at least one embodiment, the redemption request may ask the servers 116 to verify that the inputted merchant confirmation credential 126 may be used to complete the redemption of the voucher 124. Accordingly, the servers 116 may record the redemption of the voucher 124 that includes the merchant confirmation credential 126 when the merchant confirmation credential 126 is determined to be valid for completing the redemption. Otherwise, the servers 116 may cause the consumer application 122 to generate an error message. The error message may request the input of another merchant confirmation credential. In additional embodiments, the consumer application 122 may also provide other pertinent information with the redemption request. Such pertinent information may include a location of the electronic device 114 at a time of the redemption attempt, a time and/or a date of the redemption attempt, and/or so forth. The location of the electronic device 114 may be provided by an on-board geolocation component of the device (e.g., a GPS sensor). In such embodiments, the servers 116 may also use such pertinent information to determine whether the voucher 124 may be redeemed.

FIG. 3 shows illustrative user interface pages displayed on an electronic device 134. The user interface pages may enable the merchant 110 to prompt a consumer to input a consumer redemption credential to complete the redemption of a voucher. The merchant application 132 may initially display a user interface page 302. The user interface page 302 may enable the merchant 110 to look up issued vouchers that have been acquired by a consumer, such as the consumer 106. For example, the consumer 106 may walk into a business location of the merchant 110 and verbally inform the merchant 110 that he or she would like to redeem a voucher. Accordingly, the user interface page 302 may enable the merchant 110 to look up one or more vouchers acquired by the consumer 106 using a consumer identifier. For example, the user interface page 302 may include a name field 304, a customer number field 306, and/or a customer address field 308. The merchant 108 may type the name of the consumer 106 into the name field 304 to look up vouchers acquired by the consumer 106. The customer number field 306 may enable the merchant 108 to look up vouchers by a customer number of the consumer 106. Likewise, the merchant 108 may type an address of the consumer 106 into the customer address field 308 to look up vouchers by the address of the consumer 106. In other embodiments, the user interface page 302 may include fields that enable the merchant 110 to look up vouchers by other consumer identifiers of the consumer 106, such as a phone number, a social security number, a driver's license number, a date of birth, and/or so forth.

The user interface page 302 may also enable the merchant 110 to look up voucher, such as the voucher 130, by a voucher identifier. For example, the user interface page 302 may include a voucher identifier field 310 and a scan voucher option 312. The merchant 108 may type a voucher identifier into the voucher identifier field 310 to look up a voucher. The scan voucher option 312 may enable the merchant to activate an image acquisition component of the electronic device 134 to acquire a voucher identifier. For example, the image acquisition component may be a camera or a barcode reader. Accordingly, the merchant 110 may obtain the voucher identifier by scanning a barcode, reading a QR code, and/or so forth. However, in other embodiments, the user interface page 302 may also include an option that enables the electronic device 134 to obtain a consumer identifier or a voucher identifier using other techniques, such as by engaging in short range communication with another electronic device. In another example, the scan voucher option 312 may activate a card reader or other media reading device to read the voucher identifier from a portable storage device (e.g., a magnetic strip, a radio frequency identification (RFID) transmitter, a memory card, etc.) The merchant 110 may use a submit button 314 of the user interface page 302 to submit an input of voucher identifier to the merchant application 132.

The submission of a voucher identifier may cause the merchant application 132 to display the user interface page 316. The user interface page 316 may display a voucher that matches the submitted voucher identifier. For example, the user interface page 316 may display the voucher 130 in response to the submission of the voucher identifier 138. In some embodiments, the user interface page 316 may also display one or more other vouchers. For example, if the merchant 110 used the user interface page 302 to lookup vouchers for the consumer 106, the user interface page 316 may display the voucher 130 as well as one or more other vouchers acquired by the consumer 106 (e.g., voucher 318). In some embodiments, the one or more vouchers that are displayed may be location specific. In other words, the user interface page 316 may only display vouchers issued by the merchant 110 that can be redeemed at a store location at which the electronic device 134 is currently operating. Thus, in such embodiments, the electronic device 134 may use information from a geolocation component (e.g., GPS sensor) on the device to filter out a voucher from being displayed on the user interface page 316 in accordance with location restrictions in the details of the voucher.

The merchant 108 may select a voucher that is displayed in the user interface 314 to redeem using a corresponding redeem option. For example, the voucher 130 may be selected via the redeem option 320. The merchant 108 may select the voucher 130 under the direction of the consumer 106. In response to the activation of the redeem option 320, the merchant application 132 may display an alert message 322. The alert message 322 may indicate that a consumer redemption credential from the consumer 106 is needed to complete the voucher redemption. The alert message 322 may include a cancel option 324 and an acknowledgement option 326.

The selection of the acknowledgement option 326 may cause the merchant application 132 to display the user interface page 328. However, in some embodiments, the display of the alert message 322 may be eliminated. In such embodiments, the consumer application 122 may directly display the user interface page 328 once the redeem option 320 is selected. The user interface page 328 may display voucher identification information. For instance, the voucher identification information may include a merchant identifier 330, as well as the unique voucher identifier 138 of the voucher 130. The user interface page 328 may also display instructions that prompt the consumer 106 to enter the consumer redemption credential 136.

In some embodiments, the consumer 106 may enter the consumer redemption credential 136 in the form of a code into a text entry field 332 of the user interface page 328. For example, the consumer redemption credential 136 may be alphanumeric text. The merchant may use a submit option 334 to submit the consumer redemption credential 136 to the merchant application 132. Alternatively, the merchant 108 may use the cancel option 336 to abort the entry of the consumer redemption credential 136.

In other embodiments, the consumer 106 may take advantage of a short range communication component, an image acquisition component, or an acoustic receiver component of electronic device 134 to transfer the consumer redemption credential 136 to the merchant application 132. Such a transfer may function in a similar manner as the transfer of the merchant confirmation credential 126 to the consumer application 122 described in FIG. 2. For example, the consumer 106 may use a short range communication transceiver or a speaker on the electronic device 114 to transfer encrypted or unencrypted data that includes the consumer redemption credential 136 to the electronic device 134. Alternatively, the consumer 106 may speak the consumer redemption credential 136 into an acoustic receiver component of the electronic device 134, which may be processed by a speech-to-text algorithm and passed to the merchant application 132. The short range communication receiver may be a NFC transceiver, a Bluetooth transceiver, a Wi-Fi transceiver, an infrared transceiver, or a laser receiver. The data may be received by a corresponding component (e.g., a microphone) of the electronic device 134. In turn, the merchant application 132 on the electronic device 134 may extract the consumer redemption credential 136 from the received data, in which the extraction may include decryption of the data. In another example, the consumer 106 may present an image that includes the consumer redemption credential 136 to an image acquisition component (e.g., camera) of the electronic device 134. The image may be presented via a printout or an electronic display, such as a display of the electronic device 114. In turn, the merchant application 132 may extract the consumer redemption credential 136 from the image.

The merchant application 132 may send the obtained consumer redemption credential 136 as a part of a redemption request for the voucher 130 to the servers 116 of the service provider 102. In at least one embodiment, the redemption request may ask the servers 116 to verify that the inputted consumer redemption credential 136 may be used to complete the redemption of the voucher 130. Accordingly, the servers 116 may record the redemption of the voucher 130 that includes the consumer redemption credential 136 when the consumer redemption credential 136 is determined to be valid for completing the redemption. Otherwise, the servers 116 may cause the merchant application 132 to generate an error message. The error message may request the input of another consumer redemption credential. In additional embodiments, the merchant application 132 may also provide other pertinent information with the redemption request. Such pertinent information may include a location of the electronic device 134 at a time of the redemption attempt, a time and/or a date of the redemption attempt, and/or so forth. The location of the electronic device 134 may be provided by an on-board geolocation component of the device (e.g., a GPS sensor). In such embodiments, the servers 116 may also use such pertinent information to determine whether the voucher 130 may be redeemed.

While the consumer redemption credential 136 may be a single credential code in some implementations, the consumer redemption credential 136 may also be a combination of multiple credential codes in alternative implementations. For example, the consumer 106 may enter a first credential code (e.g., a phrase) in a first text entry field of the user interface page 328, and a second credential code (e.g., a personal identification number) in a second text entry field of the user interface page 328 to redeem a voucher. It will be appreciated that the first credential code and the second credential code may be different from the login name and password that the consumer 106 uses to gain access to a corresponding customer account. Indeed, the first credential code and second credential code combination is not usable for managing the settings of the customer account (e.g., modify customer account password setting, payment instrument setting, etc.). Each of the multiple credential codes may be selected by the consumer 106 or generated by the service provider 102 for the exclusive use of the consumer 106.

Thus, the user interface page 328 may be configured to prompt for each of the multiple credential codes separately, rather than concurrently. For example, the user interface page 328 may initially prompt the consumer 106 to enter a first credential code. The merchant application 132 may pass the first credential code to the service provider 102. Once the service provider 102 has verified the first credential code, the service provider 102 may direct the merchant application 132 to use the user interface page 328 to prompt the consumer 106 for the second credential code, until all the credential codes are entered. Accordingly, the service provider 102 may consider the redemption of a voucher to be valid when all of the multiple credential codes are verified by the service provider 102. Conversely, the failure to validate any one of the credential codes may cause the service provider 102 to abort the voucher redemption, and direct the merchant application 132 to generate an indicator of invalid redemption code for presentation.

In such implementations, one or more of the credential codes may be inputted using an electronic device, sometimes in conjunction with the manually input of one or more credentials into the user interface page 328. For example, the consumer 106 may initially input the first credential code using a corresponding text entry field on the user interface page 328. Subsequently, when the merchant application 132 prompts for the second credential code, the consumer 106 may transfer the second credential code from the electronic device 114 to the merchant application 132 via short range communication between the electronic device 114 and the electronic device 134. In another example, the consumer 106 may initially provide a printout of a QR code that encapsulates a first credential code, which is scanned by the electronic device 134 into the merchant application 132. Subsequently, when the merchant application 132 prompts for the second credential code, the consumer 106 may input the second credential code into the merchant application 132 using a text entry field on the user interface page 328. It will be appreciated that in some embodiments, the merchant confirmation credential 126 may similarly include multiple credential codes, and that multiple credential codes may be obtained by the consumer application 122 and verified by the service provider 102 in a similar manner.

In additional embodiments, the merchant application 132 may also provide other pertinent information with the credential verification request. Such pertinent information may include location of the electronic device 134 at a time of the redemption attempt, time and/or date of the redemption attempt, and/or so forth. The location of the electronic device 134 may be provided by an on-board geolocation component of the device (e.g., a GPS sensor). In such embodiments, the servers 116 may also use such pertinent information to determine whether the voucher 130 may be redeemed.

### Example Modules

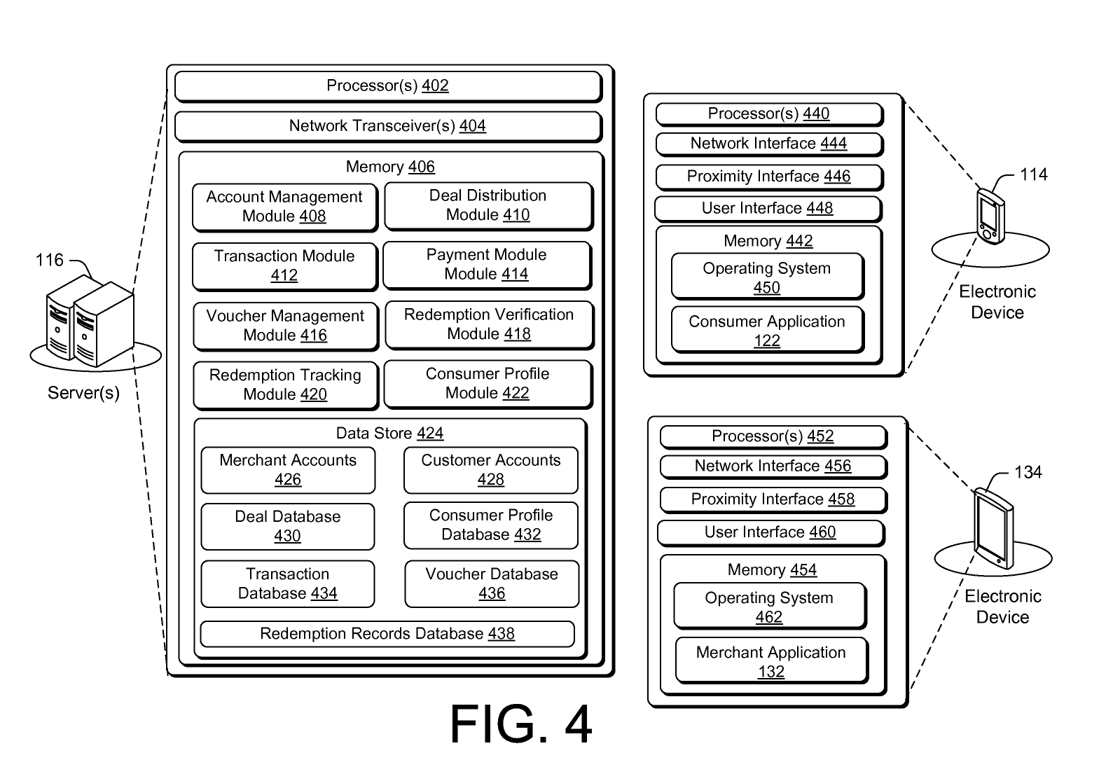

FIG. 4 is a schematic diagram of illustrative components implemented by the servers 116 of the service provider 102 to distribute deals and record the redemption of deals, along with illustrative components in electronic devices 114 and 134 that interface with the servers. The servers 116 may include one or more processors 402, one or more network transceivers 404, and memory 406. The network transceivers 404 may include wireless and/or wired communication components that enable the servers 116 to transmit data to and receive data from other servers and devices via the network 112.

The memory 406 may include computer readable media. The computer-readable media may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some embodiments the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. The processors 402 and the memory 406 may implement an account management module 408, a deal distribution module 410, a transaction module 412, a voucher management module 416, a redemption verification module 418, a redemption tracking module 420, and a consumer profile module 422. The memory 406 may also include a data store 424.

The account management module 408 may enable merchants, such as the merchant 110, to create the merchant accounts 426. The merchant 110 may establish a corresponding merchant account by providing registration information to the account management module 408 via an electronic device, such as the electronic device 134. The registration information may include a merchant name, a business name, a business address, business contact information, a login name, a password, and/or so forth. The merchant account may be a payment receivable account that enables the merchant 110 to receive payments for products, services, and/or vouchers. In various embodiments, the account management module 408 may provide authentication functions that control access to the merchant accounts 426.

Additionally, the account management module 408 may also enable consumers, such as the consumer 106, to create the customer accounts 428. The consumer 106 may establish a corresponding customer account by providing registration information to the account management module 408 via an electronic device, such as the electronic device 114. The registration information may include a customer name, a customer address, customer contact information, a login name, a password, and/or so forth. Each of the customer accounts 428 may also include account access information for one or more financial accounts that a corresponding consumer provided for paying transactions and receiving refunds. The transactions may include the purchase of products, services, and/or vouchers. In various embodiments, the account management module 408 may provide authentication functions that control access to the customer accounts 428.

The deal distribution module 410 may distribute the deals 104 to consumers, such as deals that enable consumers to acquire vouchers that can be subsequently redeemed with respect to products or services. The deals may be provided by multiple merchants, such as the merchants 108 and 110. The deal distribution module 410 may select deals that are relevant for each consumer from a deal database 430. The selection of a deal for a consumer (e.g., consumer 106) may be based on multiple factors. The factors with respect to each consumer may be stored in a consumer profile database 432. In various embodiments, the factors may include a past purchase behavior of the consumer, a geographical location of the consumer, a gender of consumer, environment factors, and/or other factors. For example, the past purchase behaviors and/or geographical location of a consumer may indicate goods or services that the consumer 106 is interested in purchasing. Likewise, the gender of the consumer may also impact the interest of the consumer in certain goods and services.

In some embodiments, the deal distribution module 410 may concurrently or alternatively use one or more additional factors, such as seasonality, to predict goods or services that may appeal to consumers. Accordingly, by taking into consideration one or more factors, the deal distribution module 410 may select deals that are relevant to each of multiple consumers. The deal distribution module 410 may distribute deals as electronic communications. The electronic communications may be in the form of emails, web pages, as well as other forms of electronic media.

The transaction module 412 may handle the processing of transactions for the acquisition of products, services, and/or vouchers. Each of the transactions may include transaction details, such as a purchase order number, a name of each item purchased, a description of each item, a cost of each item, a number of each item purchased, a purchase total, a merchant name, an identifier of a payment receivable account of a merchant, voucher terms, and/or so forth. The transaction module 412 may store the transaction details for each purchased product or service in the transaction database 434. Likewise, the transaction module 412 may store the transaction details for each acquired voucher in the voucher database 436.

The transaction details for each acquired voucher may include a voucher identifier, a merchant identifier, a consumer redemption credential, and/or a merchant confirmation credential associated with the acquired voucher. The voucher identifier of a voucher may be a unique alphanumeric identifier that identifies the voucher. The merchant identifier associated with a voucher may serve to identify the specific merchant that issued the voucher. The consumer redemption credential associated with a voucher may be credential data that a consumer customized to redeem the voucher. For example, when a consumer acquires a voucher, the consumer may designate a unique phrase or code that the consumer wants to use to redeemed the deal to the transaction module 412. In some instances, the unique phrase or code may be stored in an electronic device in possession of the consumer (e.g., a code programmed into a device memory, a device identifier, a mobile subscriber identifier, and/or so forth).

A merchant confirmation credential associated with a voucher may be credential data that merchant designated as for confirming that the voucher may be redeemed. In various embodiments, the merchant may designate multiple types of merchant confirmation credentials. For example, a merchant confirmation credential may be unique to the deal that provided the voucher, unique to a specific store location of a merchant, unique to the deal and a specific merchant store location, and/or so forth. In this way, a merchant confirmation credential may serve to provide information as to which merchant location a consumer visited to redeem a voucher.

The transaction details for each acquired voucher may also include details on the terms and conditions of the voucher. For example, the terms and conditions may include an expiration date of the voucher, limitations on locations, times, and/or dates at which the vouchers may be redeemed, restrictions on transfers or number of uses of the voucher, and/or so forth. A location restriction for a voucher may be expressed as one or more particular addresses or geographical coordinates at which the voucher may be redeemed.

The payment module 414 may arrange for the transfer of payment funds between a payment service provider of a consumer, an account of a merchant in merchant accounts 426, and/or a holding account of the service provider 102. The holding account may be used by the service provider to hold payment for pay-on-redemption. A payment service provider may be a financial institution with which the consumer 106 has established one or more financial accounts. A financial account may be a checking account, a savings account, a debit card account, a credit card account, a charge card account, a gift card account, and/or the like. In some instances, a consumer may also have arranged to have funds directly deposited in a corresponding customer account, such as one of customer accounts 428. Thus, in such instances, the payment module 414 may alternatively or concurrently arrange for the transfer of payment funds stored in a customer account of a consumer to one of the merchant accounts 426 to pay for a purchase.

In additional instances, a consumer may have credits or points stored in a corresponding customer account. The credits or points may have monetary value that is assigned by the service provider 102. A consumer may have received the credits or points in various ways. For instance, the consumer may have received the credits or points as a part of a promotion provided by the service provider 102, as a compensation from the service provider 102, as a reward from the service provider 102 for completing a particular task (e.g., service signup bonus), and/or so forth. Accordingly, the payment module 414 may also arrange for the payment of monetary value corresponding to the credits or points to a merchant account of a merchant to partially or completely pay for a purchase. Accordingly, in at least one embodiment, the payment module 414 may arrange for payment to a merchant account from multiple fund sources as directed by a consumer. In various embodiments, the payment module 414 may also collect a service fee for each arrangement of a payment for a product, a service, or a voucher. In this way, the service provider 102 may have a revenue stream for facilitating transactions between merchants and consumers.

The voucher management module 416 may handle requests for voucher information from applications on electronic devices, such as the electronic devices 114 and 134. In turn, the voucher management module 416 may provide the relevant voucher information from the voucher database 436 to the requesting devices. For example, the voucher management module 416 may provide information on the one or more vouchers that are acquired by the consumer 106 to the consumer application 122. The voucher management module 416 may provide such information following the authentication of the consumer 106 by the consumer application 122. However, in other instances, the voucher management module 416 may provide such information to the consumer application 122 on a periodic basis or following each voucher redemption in order to update the voucher information that are stored on the consumer application 122. However, the consumer application 122 may be configured to display such voucher information following user authentication. In another example, the voucher management module 416 may provide information on one or more vouchers that are acquired by the consumer 106 to the merchant application 132. The voucher management module 416 may provide such information when the merchant 110 uses the merchant application 132 to look up vouchers that may be redeemed by the consumer 106. The voucher management module 416 may use the account management module 408 to authenticate the merchant 110 in such instances before providing the information.

In some embodiments, the voucher management module 416 may provide information on one or more vouchers to an electronic device based on a geolocation of the electronic device. In such embodiments, the electronic device (e.g., electronic device 114) may have geolocation capabilities. For example, the electronic device may have the ability to ascertain its current location using an on-board GPS sensor, cellular triangulation through a cellular communication connection of the electronic device, IP address-based location positioning through a Wi-Fi connection of the electronic device, and/or so forth. Accordingly, an application on the electronic device (e.g., consumer application 122) may send a request for voucher information that includes the geolocation of the electronic device. In turn, the voucher management module 416 may examine the geolocation of the requesting electronic device, and only provide information on one or more vouchers that may be redeemed at the geolocation to the application on requesting electronic device.

The redemption verification module 418 may verify the credentials that are inputted by consumers or merchants are valid for the redemption of corresponding vouchers. For instance, when the merchant 108 inputs the merchant confirmation credential 126 into the consumer application 122 to complete the redemption of the voucher 124, the consumer application 122 may send the merchant confirmation credential 126 and the voucher identifier 128 to the redemption verification module 418. In turn, the redemption verification module 418 may verify whether the merchant confirmation credential 126 has been previously designated by the merchant 108 as for completing the voucher redemption. For example, the merchant confirmation credential 126 may be associated with the identifier 128 of the voucher 124 in the voucher database 436, and the redemption verification module 418 may use this correlation to perform the verification. If verification is successful, the redemption verification module 418 may send an indication to the redemption tracking module 420 that causes the redemption tracking module 420 to record the redemption as completed. The redemption verification module 418 may also send a redemption success message to the consumer application 122. Otherwise, the redemption verification module 418 may send an error indication to the consumer application 122. The error indication may cause the consumer application 122 to prompt for the input of another merchant confirmation credential.

In another instance, when the consumer 106 inputs the consumer redemption credential 136 into the merchant application 132 to complete the redemption of the voucher 130, the merchant application 132 may send the consumer redemption credential 136 and the voucher identifier 138 to the redemption verification module 418. In turn, the redemption verification module 418 may verify whether the consumer redemption credential 136 has been previously designated by the consumer 106 as for completing the voucher redemption. For example, the consumer redemption credential 136 may be associated with the identifier 138 of the voucher 130 in the voucher database 436, and the redemption verification module 418 may use this correlation to perform the verification. If verification is successful, the redemption verification module 418 may send an indication to the redemption tracking module 420 that causes the redemption tracking module 420 to record the redemption as completed. The redemption verification module 418 may also send a redemption success message to the merchant application 132. Otherwise, the redemption verification module 418 may send an error indication to the merchant application 132. The error indication may cause the merchant application 132 to prompt for the input of another consumer redemption credential. In some embodiments, the redemption verification module 418 may perform verification on a consumer redemption credential or a merchant confirmation credential that includes multiple credential codes. Further, the redemption verification module 418 may also be responsible for generating and sending such a consumer redemption code to an electronic device of the consumer.

The redemption verification module 418 may also take into consideration additional pertinent information when determining whether the redemption of a voucher is valid. The pertinent information may include a location of the electronic device used for redemption at a time of the redemption attempt, a time and/or a date of the redemption attempt, and/or so forth. An electronic device may supply such pertinent information as a part of a credential verification request. Accordingly, the redemption verification module 418 may compare such pertinent information to the details of a voucher to be redeemed in order to validate the redemption.

For example, the details of the voucher 130 may indicate that the voucher 130 expires three month after the date of purchase (at which point the consumer 106 is entitled to a refund). Thus, when a check of the date of the redemption by the consumer 106 indicates that the redemption attempt is outside of the three month period, the redemption verification module 418 may reject the redemption attempt, and send an error indication to the merchant application 132. In some instances, the redemption verification module 418 may also check with the redemption tracking module 420 to verify that the voucher was not previously redeemed. If the voucher was not previously redeemed, the redemption verification module 418 may direct the transaction module 412 to issue a refund to the consumer 106.

In another example, the details of the voucher 124 may indicate that the voucher 124 may only be redeemed at a first store location of the merchant 108. However, the consumer 106 may be attempting to redeem the voucher at a second store location of the merchant 108. Thus, the merchant confirmation credential 126 that is inputted into the consumer application 122 at the time of redemption may be unique to the second store location of the merchant 108. As a result, the redemption verification module 418 may reject the redemption attempt based on the location information provided by the merchant confirmation credential 126, and send an error indication to the consumer application 122 stating that the redemption of the voucher at the second location is not permitted.

In the various embodiments described above, the redemption verification module 418 may further verify each voucher redemption request with the redemption tracking module 420 based on voucher identifiers. Any indication from the redemption tracking module 420 showing that a particular voucher has already been previously redeemed may cause the redemption verification module 418 to reject a corresponding voucher redemption request, regardless of any other factors. The redemption verification module 418 may send an error indication to an application (e.g., merchant application 132) that initiated the voucher redemption request. The error indication may point out that the voucher has already been redeemed.

The redemption tracking module 420 may compile records of voucher redemption based on voucher redemption information received from electronic devices, such as the electronic devices 114 and 134. In various embodiments, the redemption tracking module 420 may compile such records as directed by the redemption verification module 418. A record of voucher redemption may include information such as a corresponding merchant confirmation credential or a consumer redemption credential that is used to redeem the voucher. The record may further include data on a time and a date of the redemption, a location of the redemption, and/or other pertinent information. In some embodiments, the location of redemption may be a location that is determine by an electronic device that sent the record. For example, the electronic device may ascertain its location using an on-board GPS sensor, cellular triangulation through a cellular communication connection of the electronic device, IP address-based location positioning through a Wi-Fi connection of the electronic device. In other embodiments, the redemption tracking module 420 may determine a location at which a voucher is redeemed based on a corresponding merchant confirmation credential used to complete the redemption. For example, the merchant confirmation credential 126 may be unique to a specific store location of the merchant 110.

The redemption tracking module 420 may store the records of voucher redemptions in the redemption records database 438. In some embodiments, the redemption records database 438 may be integrated with the voucher database 436, such that one database is used to track each acquired voucher from the time of its acquisition to the time of its redemption. The redemption tracking module 420 may further cooperate with the redemption verification module 418, so that the redemption records database 438 may be used to determine whether a voucher to be redeemed has been previously redeemed.

The consumer profile module 422 may develop consumer profiles for consumers. The consumer profiles may be stored in the consumer profile database 432. The consumers may include consumers that subscribe to the deals 104 that are provided by the service provider 102, and in some instances, consumers that have otherwise established consumer accounts with the service provider 102. The consumer profile module 422 may develop a consumer profile for a consumer based on an item purchase history of the consumer at one or more merchants, consumer activity of the consumer at one or more merchants, demographic information of the consumer, gender of the consumer, and/or so forth. The purchase history may include purchase information for one or more purchase transactions. The purchase information for a purchase transaction may include the identity of the consumer that made the purchase transaction, identification information of the merchant, the description of each item that is purchased through the transaction, the quantity of each item purchased, the price of each item purchased, whether each item is purchased through a deal offer, and/or so forth. The consumer activity of the consumer may further include information on other actions of the consumer with each of the one or more merchants, the service provider 102, or any combination thereof. The consumer activity information may include information such as one or more item browse or search histories of the consumer, one or more advertisement click-through histories of the consumer, information on one or more item reviews, one or more item ratings, one or more item recommendations that are submitted by the consumer, and/or information on other activities that may be attributed to the consumer.

The consumer profile module 422 may also integrate the information from the records of voucher redemption into consumer profiles. Such information may include a time and a date of voucher redemption, merchant location at which the voucher redemption occurred, merchants associated with the voucher, products or services acquired through the voucher, and/or so forth. In this way, the consumer profile module 422 may use such information to develop comprehensive consumer profiles for the consumers, which may be used by the deal distribution module 410 to distribute deals.

The data store 424 may store data that are used by the various modules. In at least one embodiment, the data store may store the merchant accounts 426, the customer accounts 428, the deal database 430, the consumer profile database 432, the transaction database 434, the voucher database 436, and the redemption records database 438. Each of the databases may store corresponding data using a data table, a data array, and/or other data storage structures.

The electronic device 114 may include processor(s) 440 and memory 442. The memory 442 may include computer readable media. Computer readable media may include volatile and non-volatile, removable and non-removable media implemented in any method or technology for storage of information such as computer readable instructions, data structures, program modules, or other data. As defined herein, computer readable media does not include communication media in the form of modulated data signals, such as carrier waves, or other transmission mechanisms.

The electronic device 114 may also include a network interface 444, a proximity interface 446, and a user interface 448. The network interface 444 may include wireless and/or wired communication components that enable the electronic device 114 to transmit data to and receive data from other devices via the network 112. The data may include audio signals. For example, the network interface 444 may include a cellular communication transceiver, a Wi-Fi transceiver, a wired network interface transceiver, and/or so forth.

The proximity interface 446 may include short range communication components that function independently of the network 112. In various embodiments, the proximity interface 446 may include a speaker that transmits sound waves and/or a microphone that receives sound waves, a light signal-based communication transceiver (e.g., an infrared transceiver), and/or a radio signal-based transceiver (e.g., Bluetooth transceiver) that is capable of transmitting and receiving data.

The user interface 448 may enable a user to provide inputs and receive outputs from the electronic device 114. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The electronic device 114 may include a geolocation component (e.g., a GPS sensor).

The memory 442 may store an operating system 450 and the consumer application 122. The operating system 450 may include components that enable the electronic device 114 to receive data via various inputs via the user interface 448, process the data using the processor(s) 440 to generate output. The operating system 450 may further include one or more components that present the output, including display data using the user interface 448, store data in memory, transmit data to another electronic device, and/or so forth. Additionally, the operating system 450 may include other components that perform various other functions generally associated with an operating system, such as providing an execution environment for applications that are installed on the electronic device 114.

The consumer application 122 may use the execution environment provided by the operating system 450 to interface with a user and other devices and servers. Accordingly, the consumer application 122 may perform various functions that are described herein, such as displaying one or more vouchers acquired by the consumer 106 after authenticating the consumer 106, prompt the merchant 108 to provide the merchant confirmation credential 126 for the voucher 124, and/or so forth. However, in some embodiments, the consumer application 122 may be replaced with a web browser, and the functions performed by the consumer application 122 may instead be performed by modules on the servers 116 that receive inputs and present outputs via the web browser.

Similarly, the electronic device 134 may include processor(s) 452 and memory 454. The memory 454 may include computer readable media. Computer readable media may include volatile and non-volatile, removable and non-removable media implemented in any method or technology for storage of information such as computer readable instructions, data structures, program modules, or other data. As defined herein, computer readable media does not include communication media in the form of modulated data signals, such as carrier waves, or other transmission mechanisms.

The electronic device 134 may also include a network interface 456, a proximity interface 458, and a user interface 460. The network interface 456 may include wireless and/or wired communication components that enable the electronic device 134 to transmit data to and receive data from other devices via the network 112. The data may include audio signals. For example, the network interface 456 may include a cellular communication transceiver, a Wi-Fi transceiver, a wired network interface transceiver, and/or so forth.

The proximity interface 458 may include short range communication components that function independently of the network 112. In various embodiments, the proximity interface 458 may include a speaker that transmits sound waves and/or a microphone that receives sound waves, a light signal-based communication transceiver (e.g., an infrared transceiver), and/or a radio signal-based transceiver (e.g., Bluetooth transceiver) that is capable of transmitting and receiving data.

The user interface 460 may enable a user to provide inputs and receive outputs from the electronic device 134. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The electronic device 134 may include a geolocation component (e.g., a GPS sensor).

The merchant application 132 may use the execution environment provided by the operating system 450 to interface with a user and other devices and servers. Accordingly, the merchant application 132 may perform various functions that are described herein, such as displaying one or more vouchers acquired by the consumer 106 following a consumer lookup, prompt the consumer 106 to provide the consumer redemption credential 136 for the voucher 130, and/or so forth. However, in some embodiments, the merchant application 132 may be replaced with a web browser, and the functions performed by the merchant application 132 may instead be performed by modules on the servers 116 that receive inputs and present outputs via the web browser.

### Illustrative Operations

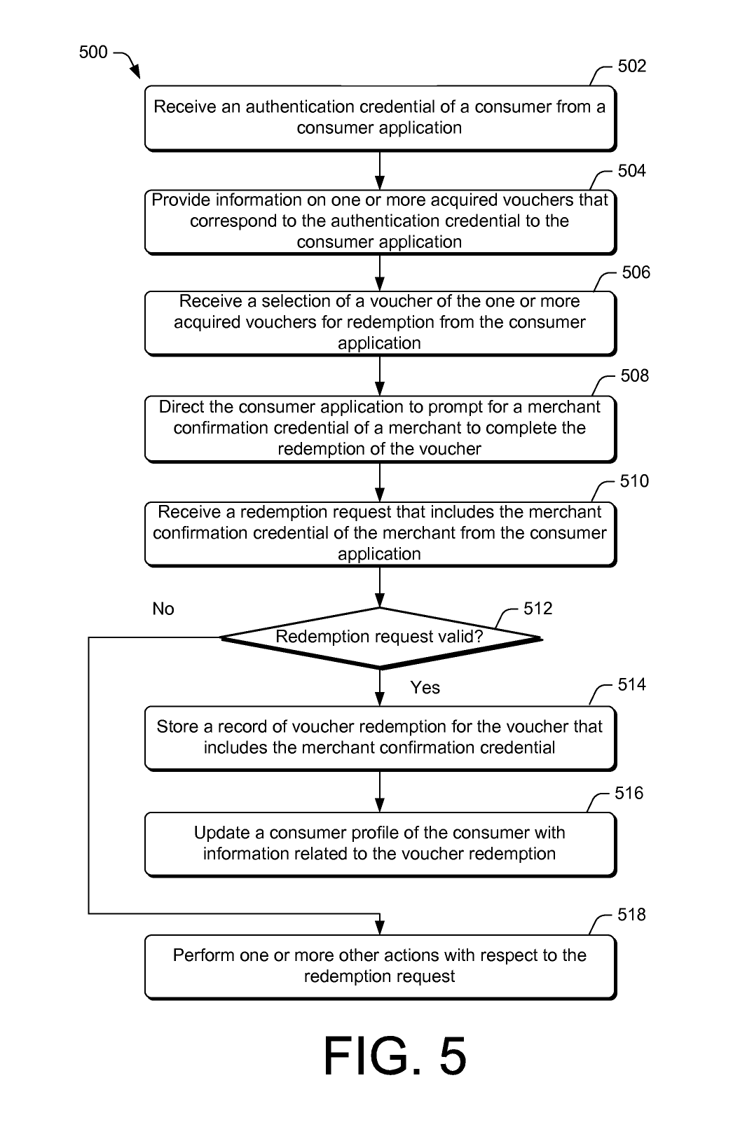

FIGS. 5-8 show illustrative processes 500-800 that implement voucher redemption confirmation and recordation. Each of the processes 500-800 is illustrated as a collection of steps in a logical flow diagram, which represents a sequence of operations that can be implemented in hardware, software, or a combination thereof. In the context of software, the steps represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, the processes 500-800 are described with reference to the architecture 100 of FIG. 1.

FIG. 5 is a flow diagram of an illustrative process 500 for using an electronic device 114 to prompt a merchant to provide a merchant confirmation credential 126 to complete redemption of a voucher by the consumer. At block 502, the account management module 408 may receive an authentication credential that is inputted by the consumer 106. For example, the consumer 106 may use the user interface page 202 to input the authentication credential into a consumer application 122. In at least one embodiment, the authentication credential may include a login name and/or a password. The consumer application 122 may send the authentication credential to the account management module 408 to be validated.

At block 504, the voucher management module 416 may provide information on one or more vouchers (e.g., the voucher 124) that are acquired by the consumer 106 to the electronic device 114. The voucher management module 416 may provide the one or more acquired vouchers when the account management module 408 determines that the authentication credential of the consumer 106 is valid. The one or more corresponding acquired vouchers may be presented by the electronic device 114. For example, the consumer application 122 may present the one or more vouchers via the user interface page 212. In various instances, the consumer 106 may have acquired a voucher by purchasing the voucher, bartering for the voucher, or gratuitously obtaining the voucher through a deal that is offered by a merchant, such as the merchant 108. The voucher may entitle the consumer 106 to a privilege with respect to a product or service that is otherwise not available without the voucher.

At bock 506, the redemption verification module 418 may receive a selection of a voucher of the one or more vouchers for redemption from the consumer application 122. For example, the consumer 106 may have select the voucher 124 for redemption by using the redeem option 218 that is displayed on the user interface page 212.

At block 508, the redemption verification module 418 may direct the consumer application 122 to prompt for a merchant confirmation credential of a merchant. The merchant confirmation credential (e.g., the merchant confirmation credential 126) may be used to complete the redemption of the voucher, such as the voucher 124. A merchant confirmation credential may be unique to a deal offer by a merchant, unique to the merchant, or unique to a particular store location operated by the merchant. In various embodiments, the merchant confirmation credential may include a single credential code (e.g., alphanumeric text), or multiple credential codes.

At block 510, the redemption verification module 418 may receive a redemption request that includes the merchant confirmation credential of the merchant. For example, the consumer application 122 may receive an input of the merchant confirmation credential 126 for the voucher 124. In turn, the consumer application 122 may send the merchant confirmation credential 126 to the redemption verification module 418 as a part of the redemption request. In various embodiments, the redemption request may further include a voucher identifier of the corresponding voucher, a time and a date of the redemption request, a location at which the redemption request is initiated, and/or so forth.

In some instances, the merchant confirmation credential may be inputted into a user interface page 226 of the consumer application 122. In other instances, another electronic device may be used to transfer the merchant confirmation credential to the electronic device 114 that is executing the consumer application 122. In still other instances, the consumer application 122 may obtain the merchant confirmation credential through an image or a sound, as acquired by a corresponding one of an image acquisition component (e.g., camera) or a sound acquisition component (e.g., a microphone) of the electronic device 114. Further, in instances in which the merchant confirmation credential includes multiple credential codes, the consumer application 122 may obtain the multiple credential codes using one or more of the acquisition techniques described above.

At decision block 512, the redemption verification module 418 may determine whether the redemption request is valid. In various embodiments, the redemption verification module 418 may determine that the redemption request is valid when the merchant confirmation credential is in fact the designated merchant credential for the redemption of the voucher. In at least one particular embodiment, the redemption request may also need to meet one or more additional criteria in order to be considered valid. The one or more criteria may include that the voucher has not been previously redeemed, that the redemption of the voucher meets a time restriction for the redemption, a date restriction for the redemption, a location restriction for the redemption, and/or so forth. Accordingly, if the redemption verification module 418 determines that the redemption request is valid (“yes” at decision block 512), the process 500 may proceed to block 514.

At block 514, the redemption tracking module 420 may store a record of the voucher redemption for the voucher that includes the merchant confirmation credential. For example, the redemption tracking module 420 may store a voucher redemption record for the voucher 124 that includes the merchant confirmation credential 126 into the redemption records database 438. In some embodiments, a voucher redemption record may also include other pertinent information, such as a time and a date of the redemption, a location of the redemption, and/or so forth.

At block 516, the consumer profile module 422 may update a consumer profile of the consumer with information related to the voucher redemption. For example, the information related to the voucher redemption may include information on each item redeemed, a time and a date of a voucher redemption, a merchant location at which the voucher redemption occurred, and/or so forth. In some embodiments, the updated consumer profile may be used by the deal distribution module 410 to distribute additional deals to the consumer.

However, at decision block 512, if the redemption verification module 418 determines that the redemption request is invalid (“no” at decision block 512), the process 500 may proceed to block 518. At block 518, the redemption verification module 418 may perform one or more other actions with respect to the redemption request. Such actions may include directing the consumer application 122 to indicate that the voucher had expired, indicate that the voucher is not valid for the particular store location, indicate that the merchant confirmation credential is incorrect, and/or so forth, depending on the nature of the one or more criteria that are not met.

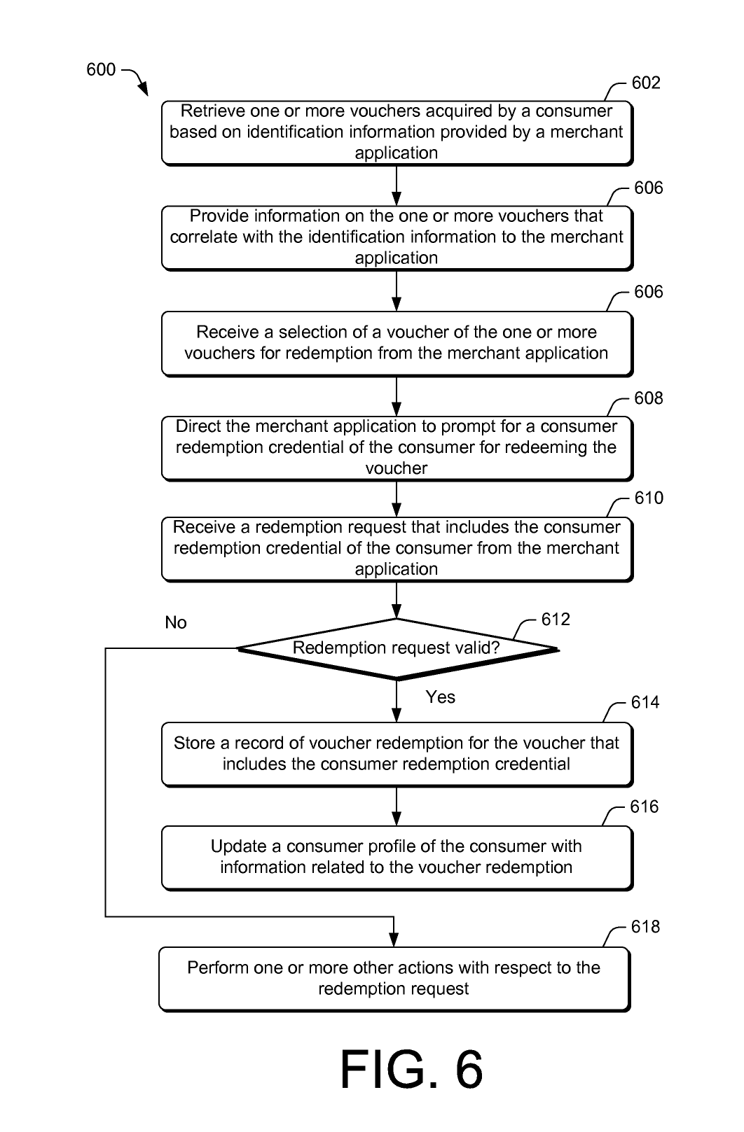

FIG. 6 is a flow diagram of an illustrative process 600 for using an electronic device to prompt a consumer to provide a consumer redemption credential to complete redemption of a voucher by the consumer. At block 602, the voucher management module 416 may retrieve one or more vouchers acquired by a consumer based on identification information provided by the merchant application 132. The one or more vouchers may be retrieved from the voucher database 436. In various embodiments, the identification information may be a consumer identifier (e.g., a name, a phone number, an address, etc.) or a voucher identifier. For example, the merchant 110 may use the user interface page 302 to input the identification information into the merchant application 132. In turn, the merchant application 132 may send the identification information to the voucher management module 416.

At block 604, the voucher management module 416 may provide information on the one or more vouchers (e.g., the voucher 130) that correlate with the identification information to the merchant application 132. Each voucher may entitle the consumer 106 to a privilege with respect to a product or service that is otherwise not available without the voucher. The consumer 106 may have acquired a voucher by purchasing the voucher, bartering for the voucher, or gratuitously obtaining the voucher through a deal that is offered by a merchant, such as the merchant 110.

At block 606, the redemption verification module 418 may receive a selection of a voucher of the one or more vouchers for redemption from the merchant application 132. For example, the merchant 110 may have indicated that the consumer 106 desires to redeem the voucher 130 by selecting the redeem option 320 presented by the user interface page 316. In turn, the merchant application 132 may pass the selection of the voucher 130 to the redemption verification module 418.

At block 608, the redemption verification module 418 may direct the merchant application 132 to prompt for a consumer redemption credential of a consumer. The consumer redemption credential (e.g., the consumer redemption credential 136) may be used to complete the redemption of the voucher, such as the voucher 130. In various embodiments, the consumer redemption credential may include a single credential code (e.g., alphanumeric text), or multiple credential codes.

At block 610, the redemption verification module 418 may receive a redemption request that includes the consumer redemption credential. For example, the merchant application 132 may receive an input of the consumer redemption credential 136. In turn, the merchant application 132 may send the consumer redemption credential 136 to the redemption verification module 418 as a part of the redemption request. In various embodiments, the redemption request may further include a voucher identifier of the corresponding voucher, a time and a date of the redemption request, a location at which the redemption request is initiated, and/or so forth.

In some instances, the consumer redemption credential may be inputted into a user interface page 328 of the merchant application 132. In other instances, another electronic device may be used to transfer the consumer redemption credential to the electronic device 134 that is executing the merchant application 132. In still other instances, the merchant application 132 may obtain the consumer redemption credential through an image or a sound, as acquired by a corresponding one of an image acquisition component (e.g., camera) or a sound acquisition component (e.g., a microphone) of the electronic device 134. Further, in instances in which the consumer redemption credential includes multiple credential codes, the merchant application 132 may obtain the multiple credential codes using one or more of the acquisition techniques described above.

At decision block 612, the redemption verification module 418 may determine whether the redemption request is valid. In some embodiments, the redemption verification module 418 may determine that the redemption request when the consumer redemption credential is in fact the designated consumer credential for the redemption of the voucher. In at least one particular embodiment, the redemption request may also need to meet one or more additional criteria in order to be considered valid. The one or more criteria may include that the voucher has not been previously redeemed, that the redemption of the voucher meets a time restriction for the redemption, a date restriction for the redemption, a location restriction for the redemption, and/or so forth. Accordingly, if the redemption verification module 418 determines that the redemption request is valid (“yes” at decision block 612), the process 600 may proceed to block 614.

At block 614, the redemption tracking module 420 may store a record of the voucher redemption for the voucher that includes the merchant confirmation credential. For example, the redemption tracking module 420 may store a voucher redemption record for the voucher 130 that includes the consumer redemption credential 136. In some embodiments, a voucher redemption record may also include other pertinent information, such as a time and a date of the redemption, a location of the redemption, and/or so forth.

At block 616, the consumer profile module 422 may update a consumer profile of the consumer with information related to the voucher redemption. For example, the information related to the voucher redemption may include information on each item redeemed, a time and a date of the voucher redemption, merchant location at which the voucher redemption occurred, and/or so forth. Accordingly, in some embodiments, the updated consumer profile may be used by the deal distribution module 410 to distribute additional deals to the consumer.

However, at decision block 612, if the redemption verification module 418 determines that the redemption request is invalid (“no” at decision block 612), the process 600 may proceed to block 618. At block 618, the redemption verification module 418 may perform one or more other actions with respect to the redemption request. Such actions may include directing the merchant application 132 to indicate that the voucher had expired, indicate that the voucher is not valid for the particular store location, indicate that the merchant confirmation credential is incorrect, and/or so forth, depending on the nature of the one or more criteria that are not met.

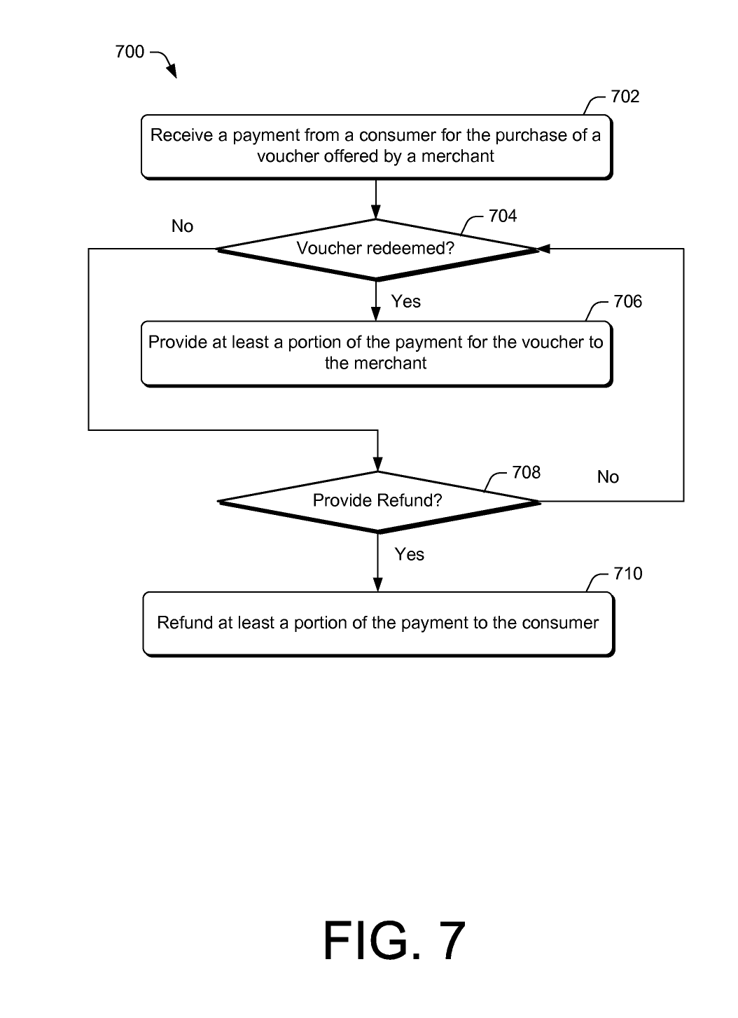

FIG. 7 is a flow diagram of an illustrative process 700 for using records of consumer voucher redemption to provide a voucher payment to a merchant or refund the voucher payment to a consumer. At block 702, the payment module 414 may receive a payment from a consumer for the purchase of a voucher offered by a merchant. For example, the consumer 106 may make payments 120 for the purchase of vouchers 118. Each purchased voucher may entitle the consumer 106 to a privilege with respect to a product or service that is otherwise not available without the voucher.

At decision block 704, the redemption tracking module 420 may determine whether the voucher has been redeemed by the consumer 106. In various embodiments, the redemption of a voucher may be contingent upon the provision of a consumer redemption credential or a merchant confirmation credential to complete the redemption. Thus, if the redemption tracking module 420 determines that the voucher is redeemed (“yes” at decision block 704), the process may proceed to block 706.

At block 706, the redemption tracking module 420 may direct the payment module 414 to provide at least a portion of the payment for the voucher to the merchant, such as the merchant 108 or the merchant 110. In some instances, the payment module 414 may send the entire payment to the merchant. In other instances, the payment module 414 may retain a portion of the payment for the deal provider 102 as a service fee and send the remainder to the merchant. However, if the redemption tracking module 420 determines that the voucher is not redeemed (“no” at decision block 704), the process 700 may continue to decision block 708.

At decision block 708, the voucher management module 416 may determine whether a refund is to be provided to the consumer 106. In one instance, a refund may be provided to the consumer 106 if the voucher management module 416 determines that the voucher had not been redeemed within a predetermined time period, i.e., the voucher had expired. In another instance, a refund may be provided to the consumer 106 if the voucher management module 416 receives a refund request from the consumer 106 for the voucher (provided that the terms and conditions of the voucher allow refunds). Thus, if the voucher management module 416 determines that a refund is to be provided to the consumer 106 (“yes” at decision block 708), the process 700 may proceed to block 710.

At block 710, the voucher management module 416 may direct the payment module 414 to refund at least a portion of the payment back to the consumer 106. In some instances, the payment module 414 may refund the entire payment to the consumer 106. In other instances, the payment module 414 may retain a portion of the payment for the deal provider 102 as a service fee and send the remainder to the consumer 106. However, if the voucher management module 416 determines that no refund is be provided to the consumer 106 (“no” at decision block 708), the process 700 may loop back to decision block 704, so that the redemption tracking module 420 may continue to monitor whether the voucher has been redeemed by the consumer 106.

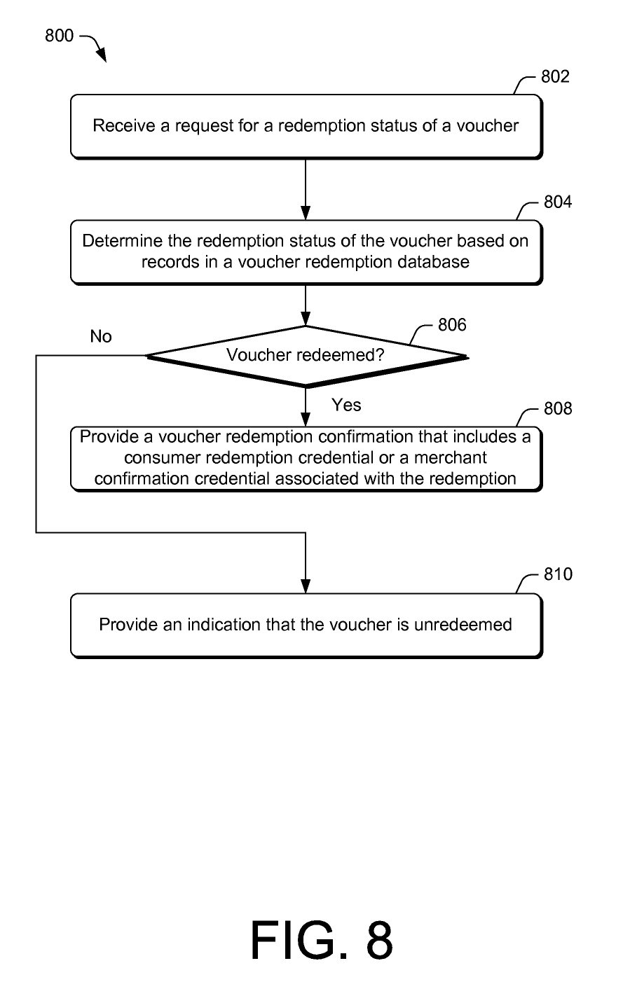

FIG. 8 is a flow diagram of an illustrative process 800 for using a record of consumer voucher redemption to provide voucher redemption status. At block 802, the redemption tracking module 420 may receive a request for a redemption status of a voucher, such as the voucher 124. The status request may be initiated by a consumer the acquired the voucher or a merchant that issued the voucher using an application. For example, the application may be the consumer application 122 on the electronic device 114 or a merchant application 132 on the electronic device 134.

At block 804, the redemption tracking module 420 may determine the redemption status of the voucher based on records in a voucher redemption database, such as the redemption records database 438. At decision block 806, if the redemption tracking module 420 determines that voucher has been redeemed (“yes” at decision block 806), the process 800 may proceed to block 808.

At block 808, the redemption tracking module 420 may provide a voucher redemption confirmation that includes a consumer redemption credential or a merchant confirmation credential that is associated with the redemption. The voucher redemption confirmation may be received and displayed by an application on an electronic device. For example, the redemption tracking module 420 may provide a redemption confirmation to the consumer application 122 that includes the merchant confirmation credential 126. In some embodiments, the voucher redemption confirmation may include additional information related to the redemption, such as a time and a date of redemption, a location of the redemption, and/or so forth.

However, if the redemption tracking module 420 determines that voucher is unredeemed (“no” at decision block 806), the process 800 may proceed to block 810. At block 810, the redemption tracking module 420 may provide an indication that the voucher is unredeemed. The indication may be received and displayed by an application on an electronic device, such as the consumer application 122 on the electronic device 114 or the merchant application 132 on the electronic device 134.

Accordingly, the systematic collection of voucher redemption information may reduce instances of redemption error or redemption fraud. For example, when a consumer disputes that the consumer has actually redeemed a voucher, the service provider may use the consumer redemption credential that is inputted by the consumer at the time of the redemption as proof that the consumer has in fact used the voucher. In other instances, the use of accurate voucher redemption records may also enable a service provider to adopt pay-on-redemption for the merchants rather than transfer the money collected from the consumers for purchased vouchers upfront. Further, the use of merchant applications and/or consumer applications to record voucher redemptions may produce highly accurate yet conveniently obtained voucher redemption records without merchants having to adopt expensive and time consuming recordkeeping systems and procedures.

The systematic collection and use of voucher redemption information by the service provider may also provide benefits to consumers. For example, since every redeemed voucher is likely to be captured by either a merchant application or a consumer application, a service provider may institute a procedure in which a consumer may be automatically refund the amount paid for a voucher if the consumer failed to use the voucher by a predetermined date. In this way, a consumer that fails to redeem a voucher may be assured of a refund even if the consumer forgets or is otherwise unable to use the voucher.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
under control of one or more computing systems of a service provider, the one or more computing systems configured with specific executable instructions,
receiving a selection of a voucher for redemption from an application on an electronic device, the voucher being acquired by a consumer and being associated with a deal offered by a merchant;
directing the application to acquire a credential to complete the redemption of the voucher, the credential being a merchant confirmation credential of the merchant or a consumer redemption credential of the consumer;
receiving the credential from the application on the electronic device;
storing a record of voucher redemption for the voucher that includes the credential in a voucher redemption database;
updating a consumer profile of the consumer with information from the record of the voucher redemption, the information including at least one of item information of each item redeemed, a time of the redemption, a date of the redemption, and a location of the redemption; and
distributing one or more additional deals to the consumer based on the consumer profile.

2. The method of claim 1, wherein the storing, the updating, and the distributing are performed in response to determining that the credential is designated for the redemption of the voucher and that one or more additional criteria are met, the one or more additional criteria including that the voucher is previously unredeemed, the redemption of the voucher meets a time restriction, the redemption of the voucher meets a date restriction, or the redemption of the voucher meets a location restriction.

3. The method of claim 1, further comprising:
receiving a payment for the voucher prior to the redemption of the voucher; and
providing at least a portion of the payment for the voucher to the merchant following the redemption of the voucher.

4. The method of claim 1, further comprising:
receiving a request for a redemption status of the voucher from a requesting application; and
providing a voucher redemption confirmation for the voucher that includes the credential to the requesting application.

5. One or more computer readable media storing computer-executable instructions that, when executed, cause one or more processors to perform acts comprising:
receiving a selection of a voucher for redemption from a consumer application, the voucher being acquired by a consumer and being associated with a deal offered by a merchant;
directing the consumer application to acquire a merchant confirmation credential of the merchant to complete the redemption of the voucher;
receiving the merchant confirmation credential of the merchant from the consumer application; and
storing a record of voucher redemption for the voucher that includes the merchant confirmation credential.

6. The one or more computer readable media of claim 5, further comprising instructions that, when executed, cause the one or more processors to perform acts that include:
receiving an authentication credential of the consumer from the consumer application, and
providing information on the voucher to the consumer application for display in response to determining that the voucher corresponds to the authentication credential.

7. The one or more computer readable media of claim 5, further comprising instructions that, when executed, cause the one or more processors to perform an act of updating a consumer profile of the consumer with information from the record of the voucher redemption, the information including at least one of item information of each item redeemed, a time of the redemption, a date of the redemption, and a location of the redemption.

8. The one or more computer readable media of claim 7, further comprising instructions that, when executed, cause the one or more processors to perform an act of distributing one or more additional deals to the consumer based on the consumer profile.

9. The one or more computer readable media of claim 5, further comprising instructions that, when executed, cause the one or more processors to perform acts that include:
receiving a payment for the voucher prior to the redemption of the voucher; and
providing at least a portion of the payment for the voucher to the merchant following the redemption of the voucher.

10. The one or more computer readable media of claim 5, further comprising instructions that, when executed, cause the one or more processors to perform acts that include:
receiving a request for a redemption status of the voucher from a requesting application; and
providing a voucher redemption confirmation for the voucher that includes the merchant confirmation credential to the requesting application.

11. The one or more computer readable media of claim 5, wherein the storing includes storing the record of voucher redemption in response to determining that the merchant confirmation credential is designated for the redemption of the voucher.

12. The one or more computer readable media of claim 11, wherein the storing includes storing the record of voucher redemption in response to further determining at least one of that the voucher is previously unredeemed, the redemption of the voucher meets a time restriction, the redemption of the voucher meets a date restriction, or the redemption of the voucher meets a location restriction.

13. The one or more computer readable media of claim 5, wherein the merchant confirmation credential is unique to the merchant, unique to the deal, unique to a business location of the merchant, or unique to the deal and the business location of the merchant.

14. The one or more computer readable media of claim 5, wherein the merchant confirmation credential includes multiple credential codes, the multiple credential codes comprising a first credential code that is a phrase and a second credential code that is a personal identification number (PIN).

15. The one or more computer readable media of claim 5, wherein the merchant confirmation credential is acquired by the consumer application through one or more of a text entry box on a user interface page provided by the consumer application, a short range communication between a first electronic device of the merchant and a second electronic device that hosts the consumer application, an image acquisition by the second electronic device, or a sound acquisition by the second electronic device.

16. The one or more computer readable media of claim 15, wherein the short range communication includes a light signal-based communication or a radio signal-based communication.

17. One or more computer readable media storing computer-executable instructions that, when executed, cause one or more processors to perform acts comprising:
receiving a selection of a voucher for redemption from a merchant application, the voucher being acquired by a consumer and being associated with a deal offered by a merchant;
directing the merchant application to acquire a consumer redemption credential of the consumer to complete the redemption of the voucher;
receiving the consumer redemption credential of the consumer from the merchant application; and
storing a record of voucher redemption for the voucher that includes the consumer redemption credential.

18. The one or more computer readable media of claim 17, further comprising instructions that, when executed, cause the one or more processors to perform acts that include:
receiving a consumer identifier or a voucher identifier from the merchant application;
retrieving information on the voucher from a voucher database based at least on the consumer identifier or the voucher identifier; and
providing the information on the voucher to the merchant application for display.

19. The one or more computer readable media of claim 17, further comprising instructions that, when executed, cause the one or more processors to perform an act of updating a consumer profile of the consumer with information from the record of the voucher redemption, the information including at least one of item information of each item redeemed, a time of the redemption, a date of the redemption, and a location of the redemption.

20. The one or more computer readable media of claim 17, wherein the storing includes storing the record of voucher redemption in response to determining that the consumer redemption credential is designated for the redemption of the voucher.

21. The one or more computer readable media of claim 20, wherein the storing includes storing the record of voucher redemption in response to further determining at least one of that the voucher is previously unredeemed, the redemption of the voucher meets a time restriction, the redemption of the voucher meets a date restriction, or the redemption of the voucher meets a location restriction.

22. The one or more computer readable media of claim 17, wherein the consumer redemption credential includes multiple credential codes, the multiple credential codes comprising a first credential code that is a phrase and a second credential code that is a personal identification number (PIN).

23. The one or more computer readable media of claim 17, wherein the merchant application acquires the consumer redemption credential through one or more of a text entry box on a user interface page provided by the merchant application, a short range communication between a first electronic device of the consumer and a second electronic device that hosts the merchant application, an image acquisition by the second electronic device, or a sound acquisition by the second electronic device.

24. The one or more computer readable media of claim 23, wherein the short range communication includes a light signal-based communication or a radio signal-based communication.

25. One or more servers, comprising:
one or more processors; and
memory storing components executable by the one or more processors, the components comprising:
a voucher management component that provides information on a voucher to an application in response to a submission of a corresponding authentication credential, a corresponding consumer identifier, or a corresponding voucher identifier, the voucher being acquired by a consumer and being associated with a deal offered by a merchant;
a redemption verification component that directs the application to acquire a credential to complete the redemption of the voucher and receives the credential from the application, the credential being a merchant confirmation credential of the merchant or a consumer redemption credential of the consumer; and
a redemption tracking component that stores a record of voucher redemption for the voucher that includes the credential in a voucher redemption database.

26. The one or more servers of claim 25, wherein the components further comprises:
a consumer profile component that updates a consumer profile of the consumer with information from the record of the voucher redemption, the information including at least one of item information of each item redeemed, a time of the redemption, a date of the redemption, and a location of the redemption;
a deal distribution component that distributes one or more additional deals to the consumer based on the consumer profile that includes information from the record of the voucher redemption; and
a payment component that receives a payment for the voucher prior to the redemption of the voucher, and provides at least a portion of the payment for the voucher to the merchant following the redemption of the voucher.

27. The one or more servers of claim 26, wherein the redemption tracking component further obtains the location of the redemption from the merchant confirmation credential when the merchant confirmation credential is unique to a business location of the merchant, or obtains the location from information provided by a positioning component of an electronic device that hosts the application.

28. The one or more servers of claim 25, where the redemption tracking component further receives a request for a redemption status of the voucher from a requesting application, and provides a voucher redemption confirmation for the voucher that includes the credential to the requesting application.

29. The one or more servers of claim 25, wherein the redemption tracking component is to provide a refund to the consumer in response to determining that an additional voucher purchased by the consumer is unredeemed at an end of a predetermined period.
